(19) United States
(12) Patent Application Publication
(10) Pub. No.: US 2001/0012099 A1
(43) Pub. Date: Aug. 9, 2001

(54) Projection exposure apparatus and method for manufacturing devices using the same

(75) Inventor: Satoru Kumagai, Chigasaki-shi (JP)

Correspondence Address: Oliff & Berridge PLC, P.O. Box 19928, Alexandria, VA, 22320, US

(73) Assignee: NIKON CORPORATION

(21) Appl. No.: 09/736,420

(22) Filed: Dec. 15, 2000

(30) Foreign Application Priority Data
Dec. 21, 1999 (JP) 11-362257

(51) Int. Cl. G03B 27/42

(52) U.S. Cl. 355/53; 355/67; 355/69; 355/71

(57) ABSTRACT

In order to provide a projection exposure apparatus capable of obtaining high optical quality in manufacturing devices with a light source using a vacuum ultraviolet light, a diffraction optical element formed on a substrate made from silica glass with a small amount of another substance (such as, for example, fluorine, hydroxyl radical, hydrogen, and/or combinations thereof), is included in the projection optical system and/or the illumination optical system of the exposure apparatus.

### BACKGROUND OF THE INVENTION

1. Field of the Invention

The present invention relates to a projection exposure apparatus and a method for manufacturing devices, and in particular, to a method suitable for manufacturing devices such as IC, LSI, CCD, liquid crystal displays, and the like by projecting a circuit pattern formed on a reticle onto a wafer through a projection optical system that includes a diffraction optical element using a light source with a vacuum ultraviolet light.

2. Description of Related Art

Projection exposure apparatus for manufacturing devices while improving the correction of aberrations by using a diffraction optical element placed in a projection optical system have been proposed, for example, in Japanese Patent Application Laid-Open Nos. 8-17719, 10-303127, and the like. These apparatus and projection optical systems correct aberrations such as axial chromatic aberration and lateral chromatic aberration by using at least one diffraction optical element.

Japanese Patent Application Laid-Open No. 8-17719 (corresponding to U.S. Pat. No. 5,636,000) discloses a technique using fluorite or silica glass as a substrate of the diffraction optical element. Japanese Patent Application Laid-Open No. 10-303127 (corresponding to EP 0 863 440) discloses a technique using fluorite as a substrate of the diffraction optical element, which is introduced into a projection optical system of a projection exposure apparatus that uses KrF, ArF or F₂ excimer lasers as a light source.

However, when a vacuum ultraviolet light is used for a light source, these known diffraction optical elements of fluorite or ordinary silica glass have problems.

Fluorite is difficult to process. Moreover, there is a problem that fluorite is liable to deform due to a temperature increase that occurs when it internally absorbs a vacuum ultraviolet light used as a light source. Further, since ordinary silica glass has a rather lower internal transmittance and lacks durability when used with a vacuum ultraviolet light, ordinary silica glass is rapidly deteriorated when used with a vacuum ultraviolet light as a light source, so that it is difficult to use.

### SUMMARY OF THE INVENTION

The invention is made in view of the aforementioned problems, and has as one object to provide a projection exposure apparatus capable of obtaining high optical quality in the manufacture of devices, by forming a substrate of a diffraction optical element from a material suitable for use with a light source having a vacuum ultraviolet light. Preferably the material is silica glass having a small quantity of another substance, such as, for example, fluorine and/or hydroxyl radical.

According to one aspect of the invention, a projection exposure apparatus includes an illumination optical system that illuminates a reticle with a vacuum ultraviolet light supplied from a light source, and a projection optical system that projects an image of an illuminated pattern formed on the reticle onto a substrate. The projection optical system includes at least one diffraction optical element formed out of a substrate made from silica glass having a small quantity of another substance.

In one preferred embodiment of the invention, a wavelength of a light supplied from the light source is shorter than 200 nm. Furthermore, it is preferable that a wavelength of a light supplied from the light source is shorter than 160 nm.

In one preferred embodiment of the invention, the diffraction optical element is formed out of a substrate made from silica glass including a small amount of fluorine, hydroxyl radical, or fluorine and hydroxyl radical having a density that is smaller than that of the fluorine.

In another preferred embodiment of the invention, the diffraction optical element is located in a position of an aperture stop of the projection optical system or in a position in the vicinity of the aperture stop, and the following conditional expression (1) is satisfied:

|LA−LD|/L≦0.2 (1)

where L denotes an interval between a substrate and a reticle of the projection optical system, LA denotes an interval between the substrate and the aperture stop of the projection optical system, and LD denotes an interval between the substrate and the diffraction optical element.

Furthermore, it is preferable to use an aspherical lens in the projection optical system.

According to another aspect of the invention, a projection exposure apparatus includes an illumination optical system that illuminates a reticle with a vacuum ultraviolet light supplied from a light source, and a projection optical system that projects an image of an illuminated pattern formed on a reticle onto a substrate. The illumination optical system includes at least one diffraction optical element that is formed out of a substrate made from silica glass including more than 100 ppm of fluorine.

In one preferred embodiment of the invention, the silica glass including more than 100 ppm of fluorine further includes hydroxyl radical. Moreover, it is preferable that the density of the hydroxyl radical is smaller than the density of the fluorine.

According to another aspect of the invention, a method for manufacturing devices includes the steps of: exposing an image of a device pattern by using the projection exposure apparatus having the above diffraction optical element, and developing the substrate after the exposing step.

### BRIEF DESCRIPTION OF THE DRAWINGS

The invention will be described in conjunction with the following drawings in which like reference numerals designate like elements and wherein:

FIG. 1 is a schematic diagram showing an exposure apparatus according to an embodiment of the invention;

FIG. 2A is a sectional view of a diffraction optical element DOE1 observed from an X direction;

FIG. 2B is a drawing explaining the function of the diffraction optical element DOE1;

FIG. 2C is a graph showing one function of the diffraction optical element DOE1;

FIG. 3 is a drawing showing a projection optical system according to an embodiment of the invention;

FIG. 4 is a sectional view conceptually showing a diffraction optical element DOE2;

FIGS. 5A, 5B and 5C are graphs showing aberrations of the projection optical system; and

FIG. 6 is a flow chart explaining a method of manufacturing devices according to an embodiment of the invention.

### DETAILED DESCRIPTION OF PREFERRED EMBODIMENTS

As for optical material to be used with a vacuum ultraviolet light, although two kinds of material such as fluorite and silica glass are known, there are the aforementioned problems when these materials are used as a substrate of a diffraction optical element.

However, it is possible to increase the durability of silica glass relative to a vacuum ultraviolet light by adding a small quantity of another substance into the silica glass.

Such a technique is disclosed, for example, in Japanese Patent Application Laid-Open No. 8-75901 (corresponding to U.S. Pat. No. 5,679,125). Although Japanese Patent Application Laid-Open No. 8-75901 discloses a technique in which silica glass including a small quantity of another substance can be employed as a material used for various optical elements such as a lens, a prism or a blank, the silica glass formed by this process has a reduced internal transmittance. Accordingly, when that silica glass is used for the material of a lens whose central portion thickness is different from (greater than) the thickness of its periphery, it is inevitable that the light quantity transmitting through the lens becomes uneven (less transmittance through the center than through the periphery) because of differences in the internal transmittance even if the unevenness is relatively small in comparison with ordinary silica glass.

However, when a substrate is designed to be a substantially plane parallel plate, such as a diffraction optical element, since unevenness of the internal transmittance between the central portion and the periphery is minimal and the thickness of the substrate can be thinner than the thickness of an ordinary lens, it becomes possible to use silica glass that includes a small quantity of another substance.

According to one aspect of the invention, a projection exposure apparatus includes an illumination optical system that illuminates a reticle with a vacuum ultraviolet light supplied from a light source, a projection optical system that projects an image of an illuminated pattern formed on the reticle onto a substrate, and at least one diffraction optical element included in the projection optical system. The diffraction optical element is formed out of a substrate made from silica glass including a small quantity of another substance.

According to another aspect of the invention, it is preferable that a vacuum ultraviolet light having a wavelength shorter than 200 nm, in particular, ArF excimer laser (wavelength: 193 nm) or the like is used for the light source. Moreover, in order to obtain higher resolution, it is preferable to use a light with a wavelength shorter than 160 nm, specifically, an F₂ excimer laser (wavelength: 157 nm).

As for the substance to be added to silica glass, fluorine, hydrogen, and hydroxyl radical are known to be a typical substance. In particular, silica glass including fluorine as well as hydrogen has exceptionally higher durability relative to a vacuum ultraviolet light than silica glass including hydrogen only. The preferable density for fluorine is more than 100 ppm, and preferably from 500 to 30000 ppm. The preferable density for hydrogen is less than 5×10¹⁸ molecules/cm³ and more preferably less than 1×10¹⁶ molecules/cm³. Thus, the process disclosed in the above-mentioned U.S. Pat. No. 5,679,125 can be used to form the diffraction optical element.

Accordingly, it is desirable that the diffraction optical element is formed out of a substrate made from silica glass including fluorine.

Moreover, the durability with respect to a vacuum ultraviolet light can be enhanced by adding hydroxyl radical into the silica glass. In this case, the preferable density of hydroxyl radical is from 10 ppb to 100 ppm. Accordingly, the diffraction optical element can be formed out of a substrate made from silica glass including hydroxyl radical.

Furthermore, silica glass including fluorine, hydrogen, and hydroxyl radical shows higher durability with respect to a vacuum ultraviolet light. However, since hydroxyl radical absorbs light in the vicinity of 150 nm, when a vacuum ultraviolet light having a wavelength shorter than 160 nm such as an F₂ excimer laser is used, the preferable density of fluorine is more than 100 ppm. On the other hand, the preferable density of hydroxyl radical is from 10 ppb to 20 ppm, so that it is preferable that the density of hydroxyl radical is at least smaller than that of fluorine included in the silica glass.

Accordingly, the diffraction optical element is preferably formed out of a substrate made from silica glass including both fluorine and hydroxyl radical, wherein the density of hydroxyl radical is less than that of the fluorine.

A projection exposure apparatus using a light source having a vacuum ultraviolet light and a diffraction optical element provided in a projection optical system will be described.

When an ArF or F₂ excimer laser is used for the light source, particularly for the F₂ excimer laser, it is extremely difficult to narrow the bandwidth of an emitted light. Accordingly, axial chromatic aberration of the projection optical system must be corrected enough for practical use even if the wavelength of the emitted light is not narrowed. Since optical material capable of being used for a vacuum ultraviolet light, particularly the light having a shorter wavelength than 160 nm, is only fluorite, it is difficult to correct axial chromatic aberration of the projection optical system up to the level of practical use with a conventional dioptric optical system. On the other hand, when a diffraction optical element formed out of a substrate made from silica glass including a small quantity of another substance is introduced into the projection optical system, it forms an optical element having dispersion opposite to an ordinary dioptric lens. Therefore, axial chromatic aberration of the projection optical system can be corrected even if the other lens elements are constructed with fluorite having superior transmittance and durability to a vacuum ultraviolet light.

Accordingly, it is desirable in the invention to arrange at least one diffraction optical element in a projection optical system.

Moreover, when a diffraction optical element is introduced into a projection optical system of a projection exposure apparatus according to the invention, the diffraction optical element is preferably arranged at the position of the aperture stop of the projection optical system in order to avoid varying aberration in accordance with a change in angle of view and to make an optimum effect on correction of axial chromatic aberration. In this construction, since unnecessary diffracted light produced by the diffraction optical element is uniformly spread on the image of the projection optical system, the influence of the unnecessary diffracted light is greatly reduced. When a variable aperture or a modified aperture is used for the aperture stop, it may not be possible to arrange the diffraction optical element at the position of the aperture stop. In this case also, it is preferable that the diffraction optical element be arranged in the vicinity of (i.e., close to) the aperture stop.

Accordingly, according to an aspect of the invention, it is preferable to arrange a diffraction optical element at the position of the aperture stop or in the vicinity of the aperture stop, wherein the following conditional expression (1) is satisfied:

|LA−LD|/L≦0.2 (1)

where L denotes an interval between a substrate and a reticle of the projection optical system, LA denotes an interval between the substrate and the aperture stop of the projection optical system, and LD denotes an interval between the substrate and the diffraction optical element.

When the ratio |LA−LD|/L exceeds the upper limit of the conditional expression (1), since an incident position of each angle of view to the diffraction optical element varies largely, it is possible that the effect of the diffraction optical element cannot be uniformly obtained on the image.

Moreover, in order to make effective use of the above-described effect, the upper limit of conditional expression (1) is preferably 0.15. Furthermore, when the upper limit is 0.1, the above-described effect can be more effectively achieved.

Further, the diffraction optical element can reduce an influence of a change in an angle of view by making differences in inclinations between respective incident light beams small. Accordingly, the diffraction optical element is preferably arranged at a position on the substrate side of the aperture stop of the projection optical system and a position satisfying the following conditional expression (2):

0≦(LA−LD)/L≦0.2 (2)

Moreover, the upper limit of conditional expression (2) is preferably 0.15. Furthermore, when the upper limit is 0.1, the above-described effect can be more effectively achieved.

It also is preferable for the projection exposure apparatus according to another aspect of the invention to have an aspherical surface in the projection optical system in order to effectively correct chromatic aberration in each monochromatic light beam.

Moreover, in order to enhance internal transmittance and durability with respect to a vacuum ultraviolet light, it is preferable that the thickness of the diffraction optical element of the projection exposure apparatus according to the invention is as follows:

t≦30 mm

where t denotes the thickness of the substrate of the diffraction optical element. It is more preferable that t≦20 mm, and further preferable that t≦15 mm. When the thickness of the substrate exceeds 30 mm, internal transmittance of the substrate becomes too small, so that the possibility that the light quantity required for the exposure cannot be obtained.

Moreover, in a projection exposure apparatus employing a vacuum ultraviolet light for a light source such as in the invention, since a direction of a diffracted light beam can be arbitrarily controlled by using a diffraction optical element in the illumination optical system, it is greatly effective for making an illumination light uniform when using a modified illumination, such as an annular illumination and the like. Further, when a laser is used for the light source, it becomes possible to reduce speckle noise (dispersion) greatly. The diffraction optical element used in an illumination optical system receives more light energy than that in the projection optical system because the illumination optical system is located closer to the light source than the projection optical system. Accordingly, the substrate of the diffraction optical element used in the illumination optical system is required to have a slightly higher durability with respect to a vacuum ultraviolet light than that in the projection optical system.

Therefore, preferably at least one diffraction optical element is included in an illumination optical system. The substrate of the diffraction optical element preferably is made from silica glass including fluorine more than 100 ppm. A more preferable density of fluorine is from 500 to 30000 ppm. Further, hydrogen is preferably included. The preferable density of hydrogen is less than 5×10¹⁸ molecules/cm³, and more preferably less than 1×10¹⁶ molecules/cm³.

Furthermore, the durability of the diffraction optical element with respect to a vacuum ultraviolet light can be further enhanced by adding hydroxyl radical into the silica glass. In this case, the preferable density of the hydroxyl radical is from 10 ppb to 100 ppm. Accordingly, it is preferable that a diffraction optical element in an illumination optical system according to the invention is formed out of a substrate made from silica glass including more than 100 ppm fluorine and hydroxyl radical.

Moreover, silica glass including fluorine, hydrogen, and hydroxyl radical shows higher durability to a vacuum ultraviolet light. However, since hydroxyl radical absorbs light in the vicinity of 150 nm, when a vacuum ultraviolet light having a wavelength shorter than 160 nm such as an F₂ excimer laser is used, the preferable density of fluorine is more than 100 ppm, and the preferable density of hydroxyl radical is from 10 ppb to 20 ppm. Thus, it is preferable that the density of hydroxyl radical is smaller than that of fluorine included in the silica glass.

Accordingly, it is preferable that silica glass including fluorine more than 100 ppm includes hydroxyl radical whose density is less than that of the fluorine. In this case, it is preferable for the density of the hydroxyl radical to be from 10 ppb to 20 ppm relative to the density of the fluorine, which is more than 100 ppm.

An embodiment of a projection exposure apparatus according to the invention will be described below with reference to the attached drawings.

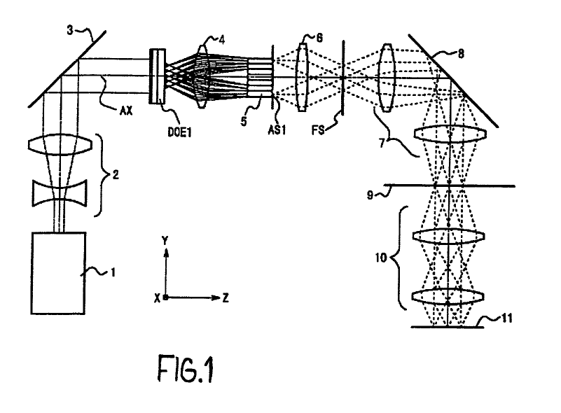

Referring to FIG. 1, a light beam of a vacuum ultraviolet light emitted from a light source 1 has its cross-sectional shape transformed to a predetermined shape by a beam expander 2, and is made incident to a diffraction optical element DOE1 via a reflection mirror 3, where it is diffracted to be a light beam having a predetermined cross-sectional shape. Then, the light beam is converged by a relay lens 4, and uniformly illuminates an incident surface of a fly-eye lens 5 in a superposing manner. As a result, a secondary light source is formed substantially on an exit surface of the fly-eye lens 5.

A light beam exiting from the secondary light source formed on the exit surface of the fly-eye lens 5 is converged by a condenser optical system 6 in a superposing manner after the shape of the light beam is limited by an aperture stop AS1. The superposed light beam uniformly illuminates a reticle 9 on which a pattern is formed in a superposing manner via a relay optical system 7. Here, a field stop FS for limiting an area of illumination is arranged in the optical path between the condenser optical system 6 and the relay optical system 7. In addition, a reflection mirror 8 is arranged in the optical path of the relay optical system 7. Accordingly, under the uniform illumination, the projection optical system 10 projects the pattern formed on the reticle onto the wafer 11, which is the object to be exposed.

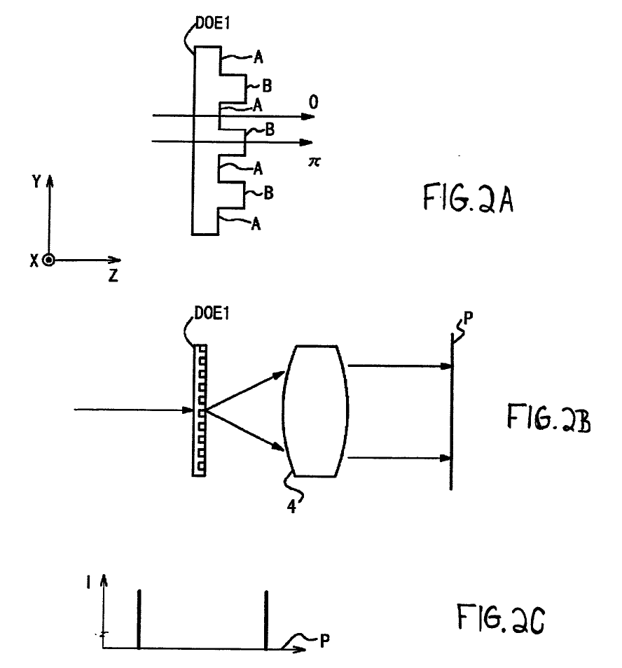

FIG. 2A is a sectional view of a diffraction optical element DOE1 observed from an X direction. The diffraction optical element DOE1 is a phase type diffraction optical element and is constructed with a plurality of minute phase patterns and transmittance patterns.

With respect to the light that is incident into the diffraction optical element DOE1, a light that passes through the portion denoted by A has a phase zero (no delay), and a light that passes through the portion denoted by B has a phase delay π. Therefore, from the point of view of wave optics, these two lights destructively interfere with each other and, as a result, the light of zero order diffraction does not come out of element DOE1 as shown in FIG. 2B. Accordingly, light that passes through the diffraction optical element DOE1 is diffracted to lights of ±1 order (or ±2 order), which pass through the relay lens 4. Then, the light becomes an illumination light having a predetermined intensity distribution of a delta (δ) function on the illumination surface P as shown in FIG. 2C. A predetermined light intensity distribution on the illumination surface P, which is the incident surface of the fly-eye lens 5, can be obtained by using this phenomenon. Since only lens elements of the fly-eye lens 5, which contribute to the illumination of the aperture stop AS1 can be illuminated by the light beam formed by the diffraction optical element DOE1 and the relay lens 4, the light quantity from the light source can be used with extremely high efficiency. This construction can be applied to any kind of modified illumination such as an annular illumination having an aperture stop AS1 with an annular shape and a quad pole illumination having a plurality of apertures in the same plane by calculating the shape suitable for each illumination.

Moreover, since the substrate of the diffraction optical element DOE1 is made from silica glass including fluorine, hydrogen, and hydroxyl radical, the silica glass has much more transmittance and durability to a vacuum ultraviolet light than ordinary silica glass even if an F₂ excimer laser is used for the light source. In this embodiment, the silica glass used for the substrate of the diffraction optical element DOE1 includes fluorine about 25000 ppm, hydrogen about 1×10¹⁶ molecules/cm³, and hydroxyl radical about 100 ppb.

In this case, when the same kind of silica glass used for the substrate of the diffraction optical element, which includes a small quantity of other substances, is used for the material composing the fly-eye lens 5, a fly-eye lens having higher transmittance and durability to a vacuum ultraviolet light than ordinary silica glass can be obtained with lower cost than that made from fluorite.

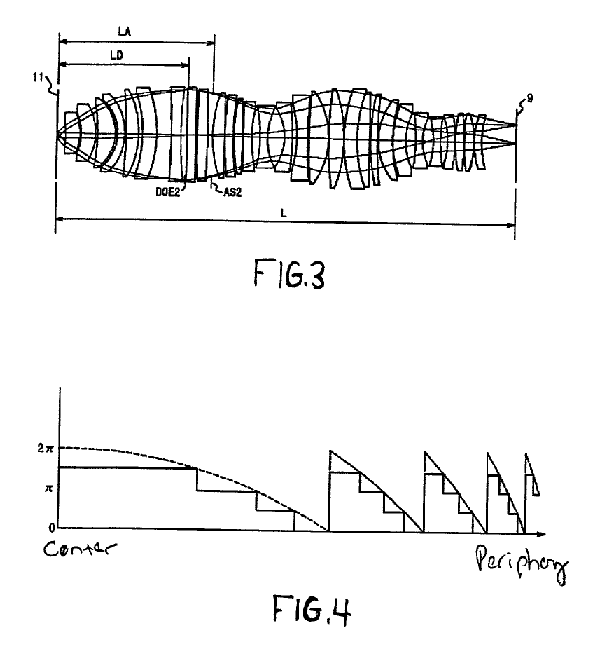

FIG. 3 is a drawing showing a projection optical system 10 of a projection exposure apparatus according to the invention. The projection optical system 10 is designed on the assumption of using an F₂ excimer laser as a light source.

The projection optical system 10 having an aperture stop AS2 inside the optical system has a diffraction optical element DOE2 arranged at the position 44.392 mm to the wafer side of the aperture stop, which is in the vicinity of the wafer. The substrate is made from silica glass including fluorine, hydrogen, and hydroxyl radical with predetermined density described later and has a thickness of 15 mm. All optical elements of the projection optical system 10 other than the diffraction optical element are made from fluorite in order to secure the utmost transmittance of the projection optical system.

The diffraction optical element DOE2 according to this embodiment is formed on the surface of the substrate made from silica glass including fluorine about 25000 ppm, hydrogen about 1×10¹⁶ molecules/cm³, and hydroxyl radical about 100 ppb. The diffraction optical element DOE2 is constructed by a BOE (binary optical element) whose sectional shape has a stepped-shape diffractive pattern, and has a positive refractive power. The diffractive pattern is a Fresnel zone pattern having an annular (concentric) shape. Specifically, the diffractive pattern has a stepped sectional shape with a larger phase difference in its central portion than that in its periphery as shown in solid line in FIG. 4 in order to converge a light beam passed through the diffractive pattern. It is desirable that the shape of the diffraction optical element DOE2 has a saw like shape as shown in dotted line in FIG. 4, which is a so-called Kinoform. However, in this embodiment, a stepped shape approximating the Kinoform shape by four steps is employed in order to make manufacturing easier. Diffraction efficiency can be enhanced by using finer steps such as eight steps, or sixteen steps in a portion or in the whole surface of the diffraction optical element DOE2. For example, the process disclosed in the above-mentioned U.S. Pat. No. 5,636,000 can be used to fabricate the diffraction optical element.

Lens data of the projection optical system 10 is shown in Table 1. In Table 1, respective values denote, in order from left to right, surface number of the optical element counted from the reticle side, radius of curvature on the optical axis, distance to an adjacent surface, refractive index of material composing each optical element at the wavelength of 157.6244 nm.

A surface with a surface number including “*” on the left is an aspherical surface. The shape of the aspherical surface is defined by assigning values of K, c, A, B, C, D, E, and F in the following expression:

z=cy²/[1+{1−(1+K)c²y²}^{½}]+Ay⁴+By⁶+Cy⁸ +Dy¹⁰+Ey¹²+Fy¹⁴

where z denotes a sag value along the optical axis, c denotes a radius of curvature, y denotes a distance from the optical axis, K denotes a conical constant, and A, B, C, D, E, and F denote aspherical constants of respective orders.

A surface having a surface number including “⊚” mark denotes a diffraction optical element. The shape of the diffraction optical element is converted into an aspherical shape expressed by the above-mentioned aspherical expression on the assumption that the refractive index of the medium is 1001.000000 in accordance with the High Index method. In this case, although the diffraction optical element is formed on the surface of the substrate, for the sake of denotation, the diffraction optical element is assumed to be an independent surface from the substrate having a thickness of zero.

TABLE 1
<Lens Data>
Magnification: 4×
NA: 0.75
Standard Wavelength λ: 157.6244 nm
Image Height (reticle side): 8 mm

| surface | | | |
|---|---|---|---|
| number | radius of curvature | surface distance | refractive index |
| 1: | INFINITY | 13.385898 | (wafer surface) |
| 2: | −280.06464 | 26.103030 | 1.559307 |
| 3: | −79.59088 | 1.426997 | |
| *4: | −81.74777 | 26.362677 | 1.559307 |

aspherical constants of the fourth surface:

| | | | |
|---|---|---|---|
| K: | 1.000000 | | |
| A: | −0.284290 × 10⁻⁷ | B: | −0.364407 × 10⁻¹⁰ |
| C: | −0.561898 × 10⁻¹⁴ | D: | 0.247226 × 10⁻¹⁷ |

| | | | |
|---|---|---|---|
| 5: | −90.76583 | 3.903834 | |
| *6: | −316.42380 | 29.319739 | 1.559307 |

aspherical constants of the sixth surface:

| | | | |
|---|---|---|---|
| K: | 1.000000 | | |
| A: | −0.933132 × 10⁻⁷ | B: | −0.578585 × 10⁻¹¹ |
| C: | 0.259908 × 10⁻¹⁵ | D: | −0.460211 × 10⁻¹⁹ |

| | | | |
|---|---|---|---|
| 7: | −75.95109 | 4.283553 | |
| 8: | −75.71360 | 13.087561 | 1.559307 |
| 9: | −94.05016 | 1.454605 | |
| 10: | −605.64738 | 22.013876 | 1.559307 |
| 11: | −157.25211 | 7.960681 | |
| 12: | −200.64824 | 24.794388 | 1.559307 |
| 13: | −208.00302 | 25.529987 | |
| 14: | −1676.63259 | 18.000000 | 1.559307 |
| 15: | 641.37609 | 11.424241 | |
| ⊚16: | 211522.98455 | 0.000000 | 1001.000000 |

converted aspherical constants of the 16th surface (DOE):

| | | | |
|---|---|---|---|
| K: | 1.000000 | | |
| A: | −0.906521 × 10⁻¹¹ | B: | 0.339565 × 10⁻¹⁵ |
| C: | 0.295360 × 10⁻¹⁹ | D: | −0.170510 × 10⁻²³ |

| | | | |
|---|---|---|---|
| 17: | INFINITY | 15.000000 | 1.643371 |
| | | | (substrate |
| | | | of DOE) |
| 18: | INFINITY | 3.391932 | |
| 19: | 1869.79373 | 18.000000 | 1.559307 |
| 20: | −3000.00000 | 8.000000 | |
| 21: | INFINITY | 2.000000 | (aperture stop) |
| 22: | 217.44124 | 21.599137 | 1.559307 |
| 23: | −3000.00000 | 1.000000 | |
| 24: | 765.07397 | 14.268482 | 1.559307 |
| *25: | 378.58845 | 1.000000 | |

aspherical constants of the 25th surface:

| | | | |
|---|---|---|---|
| K: | 1.000000 | | |
| A: | −0.435626 × 10⁻⁷ | B: | −0.920741 × 10⁻¹¹ |
| C: | 0.518240 × 10⁻¹⁵ | D: | 0.666388 × 10⁻¹⁹ |

| | | | |
|---|---|---|---|
| 26: | 307.93045 | 16.000000 | 1.559307 |
| 27: | −3000.00000 | 2.345953 | |
| 28: | −2892.02526 | 14.000000 | 1.559307 |
| *29: | 237.32016 | 15.280932 | |

aspherical constants of the 29th surface:

| | | | |
|---|---|---|---|
| K: | 1.000000 | | |
| A: | −0.522807 × 10⁻⁷ | B: | 0.167427 × 10⁻¹⁰ |
| C: | 0.170644 × 10⁻¹⁴ | D: | −0.770634 × 10⁻¹⁹ |

| | | | |
|---|---|---|---|
| *30: | −301.47670 | 14.000000 | 1.559307 |

aspherical constants of the 30th surface:

| | | | |
|---|---|---|---|
| K: | 1.0000000 | | |
| A: | −0.205956 × 10⁻⁶ | B: | −0.431195 × 10⁻¹⁰ |
| C: | 0.568636 × 10⁻¹⁴ | D: | −0.643847 × 10⁻¹⁸ |

| | | | |
|---|---|---|---|
| 31: | 112.07895 | 30.883340 | |
| *32: | −85.20146 | 13.000000 | 1.559307 |

aspherical constants of the 32nd surface:

| | | | |
|---|---|---|---|
| K: | 1.000000 | | |
| A: | 0.491546 × 10⁻¹⁰ | B: | 0.247738 × 10⁻¹⁰ |
| C: | −0.329751 × 10⁻¹⁴ | D: | 0.426600 × 10⁻¹⁸ |

| | | | |
|---|---|---|---|
| 33: | −525.60579 | 9.331439 | |
| *34: | −166.54660 | 20.191423 | 1.559307 |

aspherical constants of the 34th surface:

| | | | |
|---|---|---|---|
| K: | 1.000000 | | |
| A: | 0.449661 × 10⁻⁷ | B: | 0.105110 × 10⁻¹⁰ |
| C: | 0.232161 × 10⁻¹⁴ | D: | −0.159369 × 10⁻¹⁸ |

| | | | |
|---|---|---|---|
| 35: | 1893.77647 | 1.000000 | |
| 36: | 714.12339 | 35.828373 | 1.559307 |
| 37: | −138.90274 | 1.000000 | |
| 38: | 782.66641 | 26.247480 | 1.559307 |
| 39: | −267.87677 | 1.000000 | |
| 40: | 246.38904 | 22.000000 | 1.559307 |
| 41: | 229.45185 | 1.023316 | |
| 42: | 231.89453 | 23.000000 | 1.559307 |
| 43: | −5924.60227 | 1.000000 | |
| 44: | 378.68340 | 13.000000 | 1.559307 |
| 45: | 1000.47646 | 1.000000 | |
| 46: | 106.73614 | 25.857455 | 1.559307 |
| 47: | 274.13930 | 1.000000 | |
| 48: | 177.68065 | 21.577738 | 1.559307 |
| *49: | 112.31278 | 17.784505 | |

aspherical constants of the 49th surface:

| | | | |
|---|---|---|---|
| K: | 1.000000 | | |
| A: | −0.224465 × 10⁻⁷ | B: | 0.100168 × 10⁻¹⁰ |
| C: | 0.102318 × 10⁻¹⁵ | D: | 0.190432 × 10⁻¹⁵ |

| | | | |
|---|---|---|---|
| *50: | −305.78201 | 13.000000 | 1.559307 |

aspherical constants of the 50th surface:

| | | | |
|---|---|---|---|
| K: | 1.000000 | | |
| A: | −0.168896 × 10⁻⁶ | B: | 0.616532 × 10⁻¹⁰ |
| C: | −0.981313 × 10⁻¹⁴ | D: | 0.515630 × 10⁻¹⁸ |

| | | | |
|---|---|---|---|
| 51: | 94.65519 | 18.119989 | |
| *52: | −141.21151 | 13.000000 | 1.559307 |

aspherical constants of the 52nd surface:

| | | | |
|---|---|---|---|
| K: | 1.000000 | | |
| A: | 0.428120 × 10⁻⁷ | B: | −0.254530 × 10⁻⁹ |
| C: | 0.173849 × 10⁻¹⁴ | D: | 0.131374 × 10⁻¹⁸ |

| | | | |
|---|---|---|---|
| 53: | 227.36537 | 12.781975 | |
| *54: | −119.05532 | 13.000000 | 1.559307 |

aspherical constants of the 54th surface:

| | | | |
|---|---|---|---|
| K: | 1.000000 | | |
| A: | 0.990178 × 10⁻⁷ | B: | 0.189281 × 10⁻⁹ |
| C: | 0.125306 × 10⁻¹³ | D: | −0.540202 × 10⁻¹⁷ |

| | | | |
|---|---|---|---|
| 55: | −303.01804 | 1.000000 | |
| 56: | 236.24701 | 14.997913 | 1.559307 |
| 57: | −466.97370 | 1.000000 | |
| 58: | 509.85351 | 17.250708 | 1.559307 |
| *59: | −161.36780 | 1.000000 | |

aspherical constants of the 59th surface:

| | | | |
|---|---|---|---|
| K: | 1.000000 | | |
| A: | 0.291917 × 10⁻⁸ | B: | 0.853028 × 10⁻¹¹ |
| C: | −0.337278 × 10⁻¹⁴ | D: | 0.619379 × 10⁻¹⁸ |

| | | | |
|---|---|---|---|
| 60: | 176.09683 | 13.000000 | 1.559307 |
| *61: | 240.32668 | 59.750000 | |

aspherical constants of the 61st surface:

| | | | |
|---|---|---|---|
| K: | 1.000000 | | |
| A: | 0.111947 × 10⁻⁶ | B: | 0.250292 × 10⁻¹⁰ |
| C: | −0.792617 × 10⁻¹⁵ | D: | −0.138532 × 10⁻¹⁸ |

values for conditions
L = 818.563157
LA = 273.442999
LD = 229.051067
|LA − LD|/L = 0.05423
(LA − LD)/L = 0.05423
t = 15

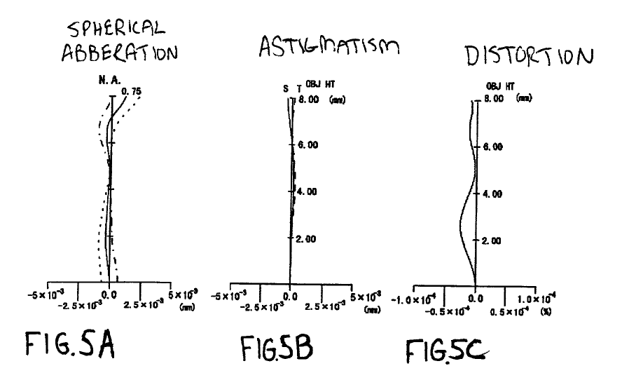

Various aberration graphs of the projection optical system 10 are shown in FIGS. 5A-5C. These aberration graphs denote aberrations obtained by ray tracing performed from the wafer side to the reticle side. FIGS. 5A, 5B, and 5C show spherical aberration, astigmatism, and distortion, respectively. In FIG. 5A, a solid line denotes spherical aberration at standard wavelength 157.6244 nm, a dashed line at 157.6232 nm, and a dotted line at 157.6256 nm, respectively. In FIG. 5B, a solid line denotes a sagittal image plane at the standard wavelength 157.6244 nm, and a dashed line denotes a meridional image plane.

FIG. 5A shows that axial chromatic aberration in particular is corrected well. Accordingly, by using the diffraction optical element, the projection optical system 10 according to the invention makes it possible to use a light source whose half-width of the wavelength is narrowed only to the extent of 1 pm, so that an F₂ excimer laser whose wavelength of the emitted light is difficult to narrow can be used for the light source. The above-mentioned half-width of the wavelength means a width of wavelength between a shorter wavelength side and a longer wavelength side of the wavelengths providing one-half of peak intensity of the emitted light from the light source.

FIGS. 5B and 5C show that astigmatism and distortion are satisfactorily corrected up to the periphery of the image.

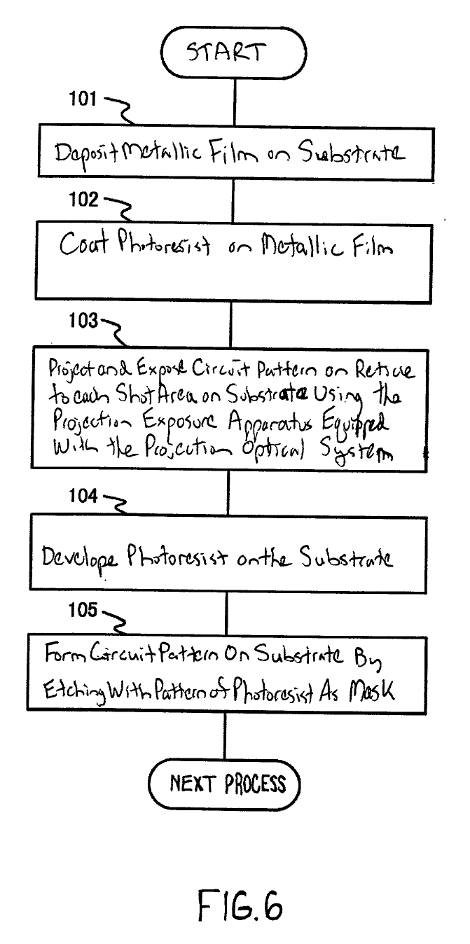

An embodiment of a procedure for forming a predetermined circuit pattern on a wafer by using the aforementioned projection exposure apparatus will be explained with reference to the flow chart shown in FIG. 6.

First, in step 101 of FIG. 6, a metallic film is deposited on a wafer of one lot. Next, in step 102, photoresist is coated on the metallic film on the wafer of one lot. Then, in step 103, a pattern image on a reticle is successively exposed and transferred to each shot area on the wafer of one lot by the projection exposure apparatus according to the aforementioned embodiment. Then, in step 104, the photoresist on the wafer of one lot is developed. In step 105, a circuit pattern corresponding to the pattern on the reticle is formed on each shot area of each wafer by etching the resist pattern as a mask on the wafer of one lot. After that, by forming a circuit pattern of an upper layer or the like, a device such as a semiconductor element or the like having an extremely fine circuit pattern is fabricated.

As described above, the present invention makes it possible to provide a projection exposure apparatus capable of extremely effectively using a light from a light source, excellently correcting axial chromatic aberration, and obtaining high optical performance with ease, even if a vacuum ultraviolet light in which only a restricted number of optical materials are available is used as a light source, and to provide a method for manufacturing devices.

The substrate, or object, on which the reticle pattern is projected by the projection optical system can be a silicon wafer, a glass or quartz plate, or other materials. Thus, the devices that can be formed by the exposure apparatus can be, for example, integrated circuits, thin-film magnetic recording heads, CCDs, liquid crystal display panels, reticles (i.e., for use in exposure apparatus to form the previously listed devices), etc.

Additionally, the exposure apparatus can be a step-and-repeat type exposure apparatus (a stepper) that performs exposure while maintaining a reticle and a substrate stationary, or a step-and-scan type exposure apparatus (a scanning stepper) that performs exposure while synchronously moving the reticle and the substrate.

While the invention has been described with reference to preferred embodiments thereof, it is to be understood that the invention is not limited to the preferred embodiments or constructions. To the contrary, the invention is intended to cover various modifications and equivalent arrangements. In addition, while the various elements of the preferred embodiments are shown in various combinations and configurations, which are exemplary, other combinations and configurations, including more, less or only a single element, are also within the spirit and scope of the invention.

What is claimed is:

1. A projection exposure apparatus comprising:
an illumination optical system that illuminates a reticle with a vacuum ultraviolet light supplied from a light source;
a projection optical system that projects an image of an illuminated pattern formed on the reticle onto a substrate; and
at least one diffraction optical element included in the projection optical system, the diffraction optical element is formed on a substrate made from silica glass including a small quantity of another substance.

2. The projection exposure apparatus according to claim 1, wherein a wavelength of the vacuum ultraviolet light supplied from the light source is shorter than 200 nm.

3. The projection exposure apparatus according to claim 1, wherein a wavelength of the vacuum ultraviolet light supplied from the light source is shorter than 160 nm.

4. The projection exposure apparatus according to claim 1, wherein the diffraction optical element is formed on a substrate made from silica glass including a small quantity of fluorine as the substance.

5. The projection exposure apparatus according to claim 1, wherein the diffraction optical element is formed on a substrate made from silica glass including a small quantity of hydroxyl radical as the substance.

6. The projection exposure apparatus according to claim 1, wherein the diffraction optical element is formed on a substrate made from silica glass including a small quantity of both fluorine and hydroxyl radical as the substance, and a density of the hydroxyl radical is smaller than a density of the fluorine.

7. The projection exposure apparatus according to claim 1, wherein the diffraction optical element is located in a position of an aperture stop of the projection optical system or in a position in a vicinity of the aperture stop, such that the following condition is satisfied:

|LA−LD|/L≦0.2
where L denotes an interval between the substrate and the reticle of the projection optical system, LA denotes an interval between the substrate and the aperture stop of the projection optical system, and LD denotes an interval between the substrate and the diffraction optical element.

8. The projection exposure apparatus according to claim 7, wherein the projection optical system includes an aspherical lens.

9. The projection exposure apparatus according to claim 1, wherein a thickness of the substrate of the diffraction optical element satisfies the following condition:
t≦30 mm
where t denotes the thickness of the substrate of the diffraction optical element.

10. The projection exposure apparatus according to claim 9, wherein t≦20 mm.

11. The projection exposure apparatus according to claim 10, wherein t≦15 mm.

12. The projection exposure apparatus according to claim 1, wherein all other optical elements in the projection optical system other than the diffraction optical element are made from fluorite.

13. The projection exposure apparatus according to claim 1, wherein the diffraction optical element is a phase-type-diffraction optical element.

14. The projection exposure apparatus according to claim 1, wherein the diffraction optical element includes a step-shaped diffraction pattern on a surface thereof.

15. The projection exposure apparatus according to claim 1, wherein the diffraction optical element includes an annular Fresnel pattern on a surface thereof.

16. The projection exposure apparatus according to claim 4, wherein the material of the diffraction optical element includes more than 100 ppm of the fluorine.

17. The projection exposure apparatus according to claim 16, wherein the material of the diffraction optical element includes between 500 ppm and 30000 ppm of the fluorine.

18. The projection exposure apparatus according to claim 5, wherein the material of the diffraction optical element includes between 10 ppb and 20 ppm of the hydroxyl radical.

19. A method for manufacturing devices comprising the steps of:
exposing an image of a device pattern onto a substrate utilizing the projection exposure apparatus according to claim 1; and
developing the substrate after the exposing step.

20. A projection exposure apparatus comprising:
an illumination optical system that illuminates a reticle with a vacuum ultraviolet light supplied from a light source;
a projection optical system that projects an image of an illuminated pattern formed on the reticle onto a substrate; and
at least one diffraction optical element included in the illumination optical system, the diffraction optical element is formed on a substrate made from silica glass including more than 100 ppm of fluorine.

21. The projection exposure apparatus according to claim 20, wherein the silica glass further includes hydroxyl radical.

22. The projection exposure apparatus according to claim 21, wherein a density of the hydroxyl radical is smaller than a density of the fluorine.

23. The projection exposure apparatus according to claim 20, wherein the material of the diffraction optical element includes between 500 ppm and 30000 ppm of the fluorine.

24. The projection exposure apparatus according to claim 21, wherein the material of the diffraction optical element includes between 10 ppb and 20 ppm of the hydroxyl radical.

25. The projection exposure apparatus according to claim 20, wherein a wavelength of the vacuum ultraviolet light supplied from the light source is shorter than 200 nm.

26. The projection exposure apparatus according to claim 20, wherein a wavelength of the vacuum ultraviolet light supplied from the light source is shorter than 160 nm.

27. The projection exposure apparatus according to claim 20, wherein a thickness of the substrate of the diffraction optical element satisfies the following condition:
t≦30 mm
where t denotes the thickness of the substrate of the diffraction optical element.

28. The projection exposure apparatus according to claim 27, wherein t≦20 mm.

29. The projection exposure apparatus according to claim 28, wherein t≦15 mm.

30. The projection exposure apparatus according to claim 20, wherein the diffraction optical element is a phase-type-diffraction optical element.

31. The projection exposure apparatus according to claim 20, wherein the diffraction optical element includes a step-shaped diffraction pattern on a surface thereof.

32. The projection exposure apparatus according to claim 20, wherein the diffraction optical element includes an annular Fresnel pattern on a surface thereof.

33. A method for manufacturing devices comprising the steps of:
exposing an image of a device pattern onto a substrate utilizing the projection exposure apparatus according to claim 20; and
developing the substrate after the exposing step.

34. A method of making a projection exposure apparatus comprising:
providing an illumination optical system that illuminates a reticle with a vacuum ultraviolet light supplied from a light source;
providing a projection optical system that projects an image of an illuminated pattern formed on the reticle onto a substrate; and
including at least one diffraction optical element in at least one of the illumination optical system and the projection optical system, the diffraction optical element is formed on a substrate made from silica glass including a small quantity of another substance.

35. The method according to claim 34, wherein the diffraction optical element is formed on a substrate made from silica glass including a small quantity of fluorine as the substance.

36. The method according to claim 34, wherein the diffraction optical element is formed on a substrate made from silica glass including a small quantity of hydroxyl radical as the substance.

37. The method according to claim 34, wherein the diffraction optical element is formed on a substrate made from silica glass including a small quantity of both fluorine and hydroxyl radical as the substance, and a density of the hydroxyl radical is smaller than a density of the fluorine.

38. The method according to claim 34, wherein the diffraction optical element is located in a position of an aperture stop of the projection optical system or in a position in a vicinity of the aperture stop, such that the following condition is satisfied:

|LA−LD|/L≦0.2
where L denotes an interval between the substrate and the reticle of the projection optical system, LA denotes an interval between the substrate and the aperture stop of the projection optical system, and LD denotes an interval between the substrate and the diffraction optical element.

39. The method according to claim 34, wherein a thickness of the substrate of the diffraction optical element satisfies the following condition:
t≦30 mm
where t denotes the thickness of the substrate of the diffraction optical element.

40. The method according to claim 39, wherein t≦20 mm.

41. The method according to claim 40, wherein t≦15 mm.

42. The method according to claim 34, wherein the diffraction optical element is a phase-type-diffraction optical element.

43. The method according to claim 34, wherein the diffraction optical element includes a step-shaped diffraction pattern on a surface thereof.

44. The method according to claim 34, wherein the diffraction optical element includes an annular Fresnel pattern on a surface thereof.

45. The method according to claim 35, wherein the material of the diffraction optical element includes more than 100 ppm of the fluorine.

46. The method according to claim 45, wherein the material of the diffraction optical element includes between 500 ppm and 30000 ppm of the fluorine.

47. The method according to claim 36, wherein the material of the diffraction optical element includes between 10 ppb and 20 ppm of the hydroxyl radical.

48. A method of performing projection exposure comprising:
illuminating a reticle with a vacuum ultraviolet light supplied from a light source to an illumination optical system;
projecting an image of an illuminated pattern formed on the reticle onto a substrate with a projection optical system; and
passing exposure light used for the exposure through at least one diffraction optical element located in at least one of the illumination optical system and the projection optical system, the diffraction optical element is formed on a substrate made from silica glass including a small quantity of another substance.

49. The method according to claim 48, wherein the diffraction optical element is formed on a substrate made from silica glass including a small quantity of fluorine as the substance.

50. The method according to claim 48, wherein the diffraction optical element is formed on a substrate made from silica glass including a small quantity of hydroxyl radical as the substance.

51. The method according to claim 48, wherein the diffraction optical element is formed on a substrate made from silica glass including a small quantity of both fluorine and hydroxyl radical as the substance, and a density of the hydroxyl radical is smaller than a density of the fluorine.

52. The method according to claim 48, wherein the diffraction optical element is located in a position of an aperture stop of the projection optical system or in a position in a vicinity of the aperture stop, such that the following condition is satisfied:

|LA−LD|/L≦0.2
where L denotes an interval between the substrate and the reticle of the projection optical system, LA denotes an interval between the substrate and the aperture stop of the projection optical system, and LD denotes an interval between the substrate and the diffraction optical element.

53. The method according to claim 48, wherein a thickness of the substrate of the diffraction optical element satisfies the following condition:
t≦30 mm
where t denotes the thickness of the substrate of the diffraction optical element.

54. The method according to claim 53, wherein t≦20 mm.

55. The method according to claim 54, wherein t≦15 mm.

56. The method according to claim 48, wherein the diffraction optical element is a phase-type-diffraction optical element.

57. The method according to claim 48, wherein the diffraction optical element includes a step-shaped diffraction pattern on a surface thereof.

58. The method according to claim 48, wherein the diffraction optical element includes an annular Fresnel pattern on a surface thereof.

59. The method according to claim 49, wherein the material of the diffraction optical element includes more than 100 ppm of the fluorine.

60. The method according to claim 59, wherein the material of the diffraction optical element includes between 500 ppm and 30000 ppm of the fluorine.

61. The method according to claim 50, wherein the material of the diffraction optical element includes between 10 ppb and 20 ppm of the hydroxyl radical.

62. The method according to claim 48, wherein a wavelength of the vacuum ultraviolet light supplied from the light source is shorter than 200 nm.

63. The method according to claim 48, wherein a wavelength of the vacuum ultraviolet light supplied from the light source is shorter than 160 nm.
